(19) United States
(12) Patent Application Publication
(10) Pub. No.: US 2013/0040668 A1
(43) Pub. Date: Feb. 14, 2013

(54) MOBILE APPLICATION FOR A PERSONAL ELECTRONIC DEVICE

(71) Applicants: Gerald Henn, Hudson, OH (US); Matt Hirschbiel, Virgina Beach, VA (US)

(72) Inventors: Gerald Henn, Hudson, OH (US); Matt Hirschbiel, Virgina Beach, VA (US)

(21) Appl. No.: 13/570,219

(22) Filed: Aug. 8, 2012

Related U.S. Application Data
(60) Provisional application No. 61/521,200, filed on Aug. 8, 2011.

(51) Int. Cl. H04W 4/14; H04W 88/00; G06F 3/02

(52) U.S. Cl. 455/466; 345/168; 455/566

(57) ABSTRACT

A personal electronic device is disclosed herein. The personal electronic device includes a display. The personal electronic device also includes at least one of a physical and virtual keypad. The personal electronic device also includes internal memory. The personal electronic device also includes a first program saved on the internal memory. When running, the first program is operable to maintain a library of contacts. The display is operable to display one or more of the contacts of the library. The personal electronic device also includes a second program saved on the internal memory. When running, the second program is operable to maintain a library of notes. The second program is also operable to establish links between at least one of the notes and one of the contacts.

### CROSS-REFERENCE TO RELATED APPLICATIONS

This application claims the benefit of U.S. Provisional Patent Application Ser. No. 61/521,200 for a MOBILE APPLICATION FOR A PERSONAL ELECTRONIC DEVICE, filed on Aug. 8, 2011, which is hereby incorporated by reference in its entirety.

### BACKGROUND OF THE INVENTION

1. Field of the Invention

The invention generally relates to methods and applications of software for personal electronic devices, such as smart phones, tablet computers, portable media players, and personal digital assistants. The invention also includes the electronic devices executing the methods.

2. Description of Related Prior Art

Personal electronic devices, including smartphones, tablet computers, portable media players, personal digital assistants, information appliances, and other mobile or wireless devices, use a mobile operating system, commonly referred to as a mobile OS. The mobile operating system controls the personal electronic device similar to the operating system for a personal computer, such as a desktop or laptop computer. Mobile operating systems include Apple's iOS, Google's Android, Nokia's Symbian, RIM's BlackBerry OS, Microsoft's Windows Phone, Linux, Palm/HP's WebOS, Samsung's Bada, Nokia's Maemo and MeeGo among many others. Android, Bada, WebOS and Maemo are built on top of Linux, and iOS is derived from the BSD and NeXTSTEP operating systems, which are related to Unix.

The personal electronic devices use mobile operating system software which provides a platform for application developers to develop application software or mobile applications. These mobile applications, or apps, are either pre-installed on the devices during manufacture, or downloaded by users from any of the various mobile application distribution platforms. These applications can be written in many different programming languages including, but not limited to, C, C++, C#, Java, JavaScript, Objective-C, XML, and HTML.

Evernote is one online application that can create and save notes online. However, there is currently no method or system of linking a note to a contact on a personal electronic device. Therefore, what is needed is a method and system of composing and linking notes to contacts on personal electronic devices.

### SUMMARY OF THE INVENTION

In summary, the invention is a personal electronic device. The personal electronic device includes a display. The personal electronic device also includes at least one of a physical and virtual keypad. The personal electronic device also includes internal memory. The personal electronic device also includes a first program saved on the internal memory. When running, the first program is operable to maintain a library of contacts. The display is operable to display one or more of the contacts of the library. The personal electronic device also includes a second program saved on the internal memory. When running, the second program is operable to maintain a library of notes. The second program is also operable to establish links between at least one of the notes and one of the contacts.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 illustrates a personal electronic device in a mobile communications network, according to one embodiment;

FIG. 2 is illustrates the display of a personal electronic device, according to one embodiment;

FIG. 3 is illustrates the display of a personal electronic device showing a note application, according to one embodiment;

FIG. 4 is illustrates the display of a personal electronic device showing a contact library, according to one embodiment;

FIG. 5 is illustrates the display of a personal electronic device showing an individual contact linked to a note, according to one embodiment;

FIG. 6 is illustrates the display of a personal electronic device showing a note linked to contacts, according to one embodiment;

FIG. 7 is illustrates the display of a personal electronic device showing a call with a contact and the notes linked to the contact, according to one embodiment; and

FIG. 8 is illustrates the display of a personal electronic device showing a text message with a contact and the notes linked to the contact, according to one embodiment.

### DETAILED DESCRIPTION OF AN EXEMPLARY EMBODIMENT

The invention, as demonstrated by the exemplary embodiment described below, provides a mobile application for a personal electronic device that can link text or multimedia notes to one or more contacts. A user can create or edit a note at any time during the operation of the personal electronic device including, but not limited to, before, after, or during a telephone call. When a telephone call with a contact ends, the mobile application can prompt the user to create a note for the contact and link the note to the contact. The note can reappear after a set length time, when the contact is accessed, or when the contact calls or is called.

One advantage of the exemplary embodiment of the invention is that notes can be composed and linked to a contact or multiple contacts at any time including before calling the contact, during a call with the contact, or after the call with the contact. Another advantage of the exemplary embodiment of the invention is that the app can run on the personal electronic device and does not need to synchronize with a database accessible through the Internet.

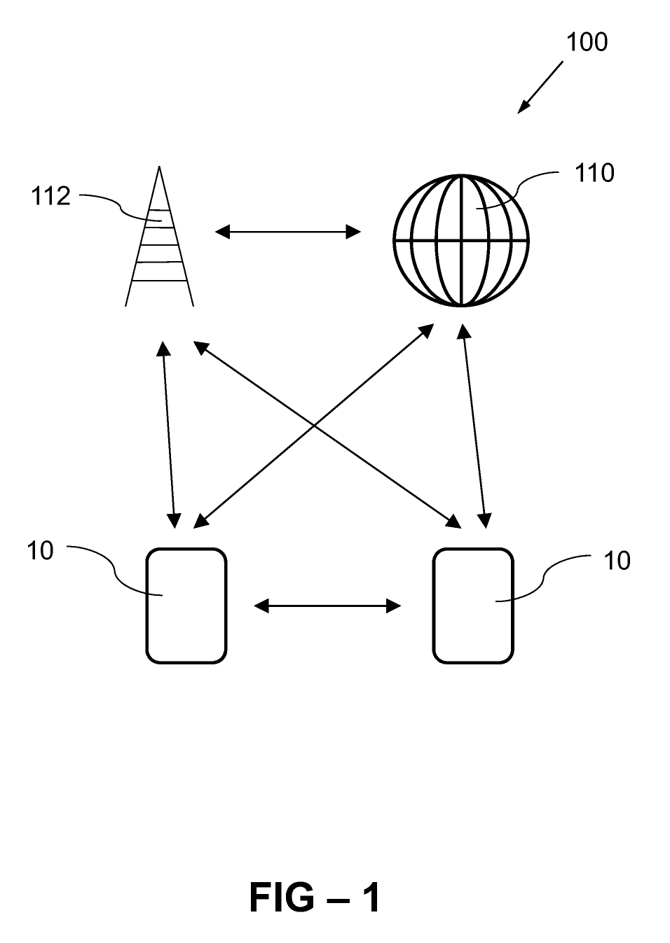

Referring now to the drawings wherein the showings are for purposes of illustrating embodiments of the invention only and not for purposes of limiting the same, and wherein like reference numerals are understood to refer to like components, FIG. 1 illustrates a personal electronic device 10 in a mobile communications network 100. The personal electronic device 10 can communicate directly with another personal electronic device 10, through one or more cellular networks 112, and via the Internet 110. The personal electronic devices 10 can communicate directly with each other through, for example, Bluetooth. The personal electronic devices 10 can communicate with the Internet 110 through, for example, a Wi-Fi connection, or through the cellular network 112.

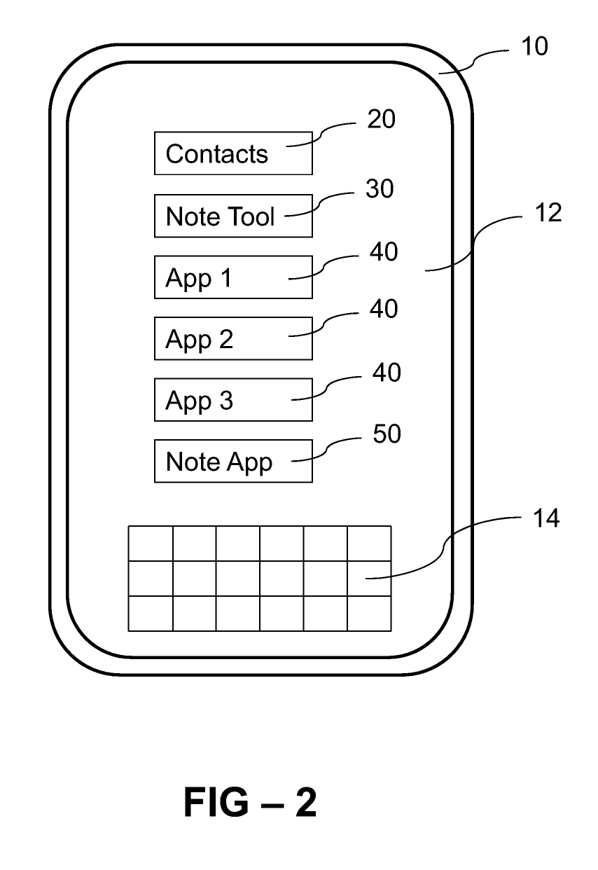

With reference to FIG. 2, a personal electronic device 10, for example, a smart phone, can include a display 12 and a physical or virtual keyboard or keypad 14. The personal electronic device 10 can include a list or library of contacts 20, a multimedia document or note drafting tool 30, one or more apps 40, and a note app 50. The library of contacts 20 can be viewed as a first program stored on the memory (internal) of the personal electronic device 10 and the note app 50 can be viewed as a second program. The note app 50 can run or operate whenever the personal electronic device 10 is operating and can be manually activated or deactivated by a user. The note app 50 can activate when the personal electronic device 10 is turned on, and then deactivate when the personal electronic device 10 is turned off. The personal electronic device 10 can include a receiver operable to receive signals corresponding to telephone calls, rendering the personal electronic device 10 a phone. The personal electronic device 10 can include one or more receivers operable to receive signals corresponding to text messages, instant messages, or electronic mail messages (hereafter emails). Likewise, the personal electronic device 10 can include appropriate transmitter(s) rendering the personal electronic device operable to send signals corresponding to one or more of phone calls, text messages, instant messages, and emails. The note app 50 can activate when the personal electronic device 10 receives a telephone call, a text message, an instant message, or any other type of communication, and then deactivate when the call or communication has been completed. The note app 50 can activate when the telephone call, a text message, an instant message, or any other type of communication ends. The note app 50 can activate when the contact list or library 20 is accessed and then deactivate when the contact list 20 is closed or shut down. It should be noted that the note app 50 can be activated by communications received from others and can also be accessed as desired by the user, without first receiving a communication from someone else.

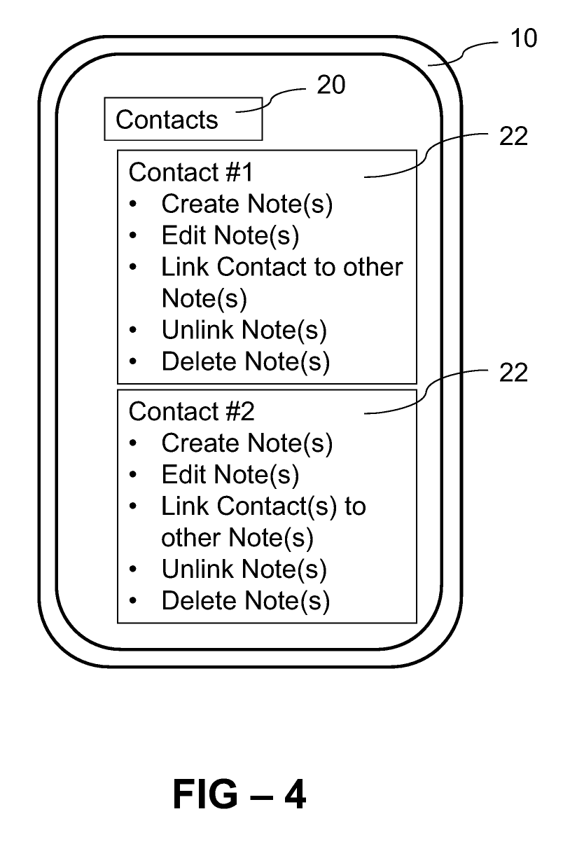

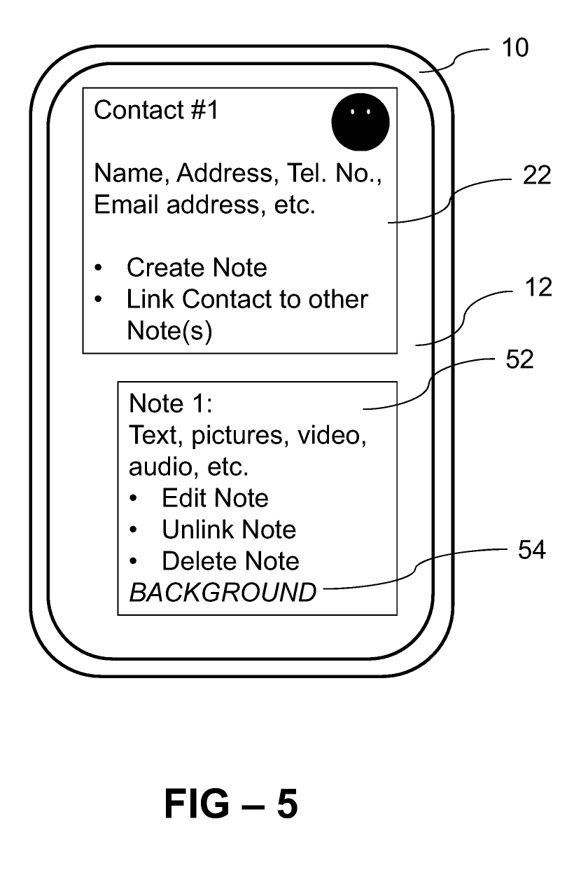

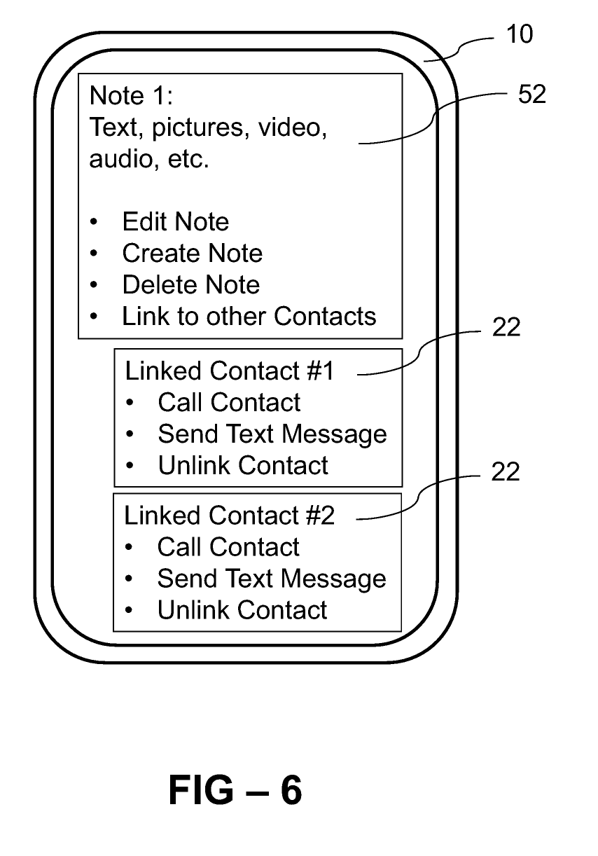

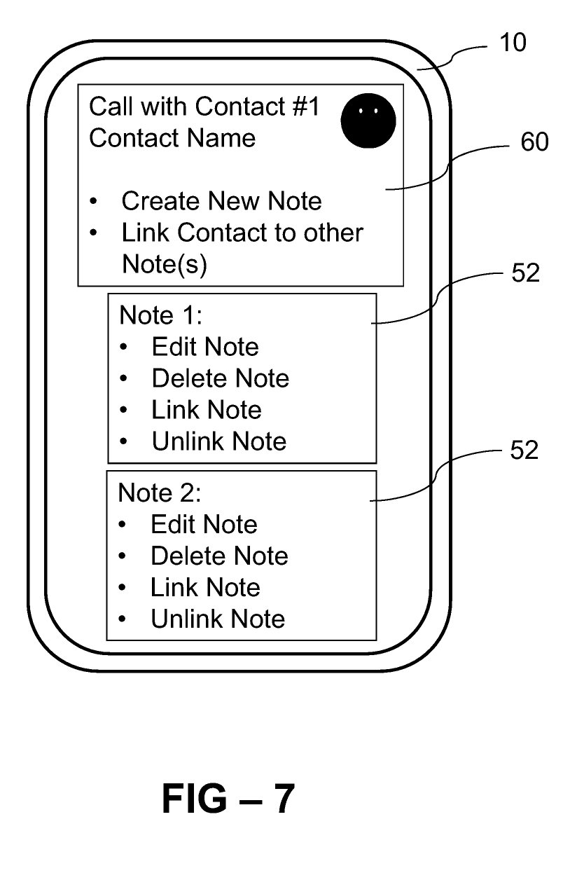

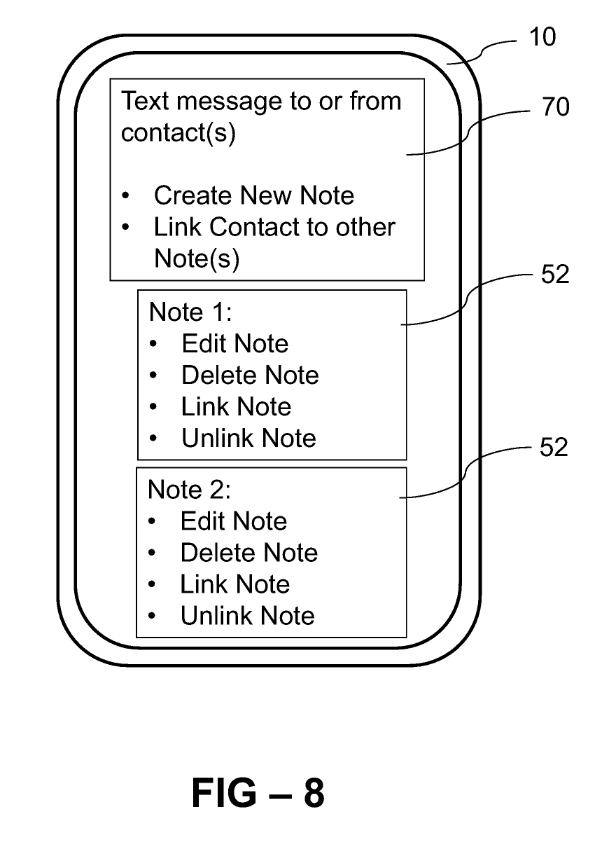

With reference to FIGS. 2-8, the note app 50 can create, edit, and delete notes 52 which the note app 50 can attach or link, or unlink, to one or more contacts 22. The note 52 can include text, pictures, video clips, and audio clips. A note 52 can be composed or edited and then linked to a contact or multiple contacts at any time during operation of the personal electronic device 10. A note 52 can be composed or edited and then linked to a contact before a call 60 or other communication 70 with a contact 22, during a call 60 or other communication 70 with a contact 22, or after the call 60 or other communication 70 with a contact 22. When the user views a contact 22, calls a contact 22, receives a call from a contact 22, or composes a text message for a contact 22, the note app 50 can automatically display any existing notes 52 linked to the contact or contacts 22. The note app 50 can also delete or unlink one or more notes 52 from a contact or multiple contacts at any time during operation of the personal electronic device 10. From either the contact library 20 or an individual contact 22, the note app 50 can create a note, edit an existing note, delete a note, link the contact to one or more note, unlink the contact from one or more notes, or call or otherwise communicate the contact.

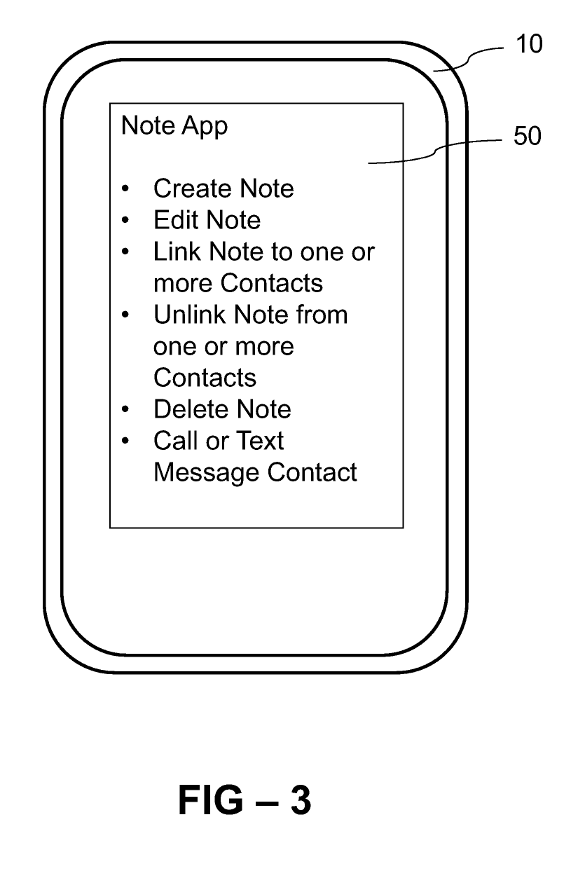

The note app 50 can display a note 52 until the user closes the note, deletes the note, ends the call, or for a specified length of time which can be set by a user. The user can manually review the existing notes 52 and then call or send a text message to a contact or contacts 22 directly from the note 52. The note app 50 can initiate the call or open a text message directly from the note 52. FIG. 3 shows a various buttons marked by bullet points. Each button can allow the user to execute a different function. The button “Call or Text Message Contact” can be selected by the user (by touch screen activation or other method) to place a call or start a text message directly from the note 50. In other embodiments, email messages can also be started through a button displayed in the note 50. The user can set a timer on each note 52 so that the note automatically re-appears at a specific date and time or after a specified amount of time. The background of the note 52 can include a background 54 similar to a watermark on paper or documents. The background 54 can be customizable by the user to include text or pictures. The background 54 can include advertisements from various companies or messages from sponsors. Each note 52 can have a different or the same background 54. From the note 52, the note app 50 can edit the note, create another note, delete the note, link the note to one or more contacts, unlink the note from one or more contacts, or call or otherwise communicate with a contact.

After a telephone call 60 ends or a text message 70 is sent, the note app 50 can prompt the user to create a new a note 52, edit one or more an existing notes 52, link an existing note 52 to other contacts, delete one or more existing notes 52, or unlink one or more an existing notes 52. If the user selects create a new note 52, the note app 50 generates a new note 52, and the user can then enter text, pictures, video clips, and audio clips in the note 52. After the user completes composing the note 52, the user selects which contact or contacts 22 to attach or link the note 52. The note app 50 then attaches or links the note 52 to the selected contact or contacts 22. The user can call or text the contact or contacts 22 from the note 52 before the note 52 closes.

When the user accesses a contact 22 in the contact library 20, the note app 50 can prompt the user to create a new note 52, edit one or more an existing notes 52, link an existing note 52 to one or more other contacts, delete one or more existing notes 52, or unlink one or more an existing notes 52. If the user selects create a new note 52, the note app 50 generates a new note 52. After the user completes composing the note 52, the user selects which contact or contacts 22 to attach or link the note 52. The user can then call or text the contact or contacts 52 from the note 52 before the note 52 closes.

Embodiments of the invention can also include a contact proximity sensor that operates as follows. The contact proximity sensor can be internal to the user's personal electronic device and communicate with the controller of the personal electronic device. Thus, the second program can be activated by conditions sensed by the contact proximity sensor. For example, when a personal electronic device of a one of the user's contacts is within the range of the contact proximity sensor, the personal electronic device can activated and all notes associated with the contact can be displayed.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Further, the “invention” as that term is used in this document is what is claimed in the claims of this document. The right to claim elements and/or sub-combinations that are disclosed herein as other inventions in other patent documents is hereby unconditionally reserved.

What is claimed is:

1. A personal electronic device comprising:
a display;
at least one of a physical and virtual keypad;
internal memory;
a first program saved on said internal memory and when running operable to maintain a library of contacts, wherein said display is operable to display one or more of said contacts of said library; and
a second program saved on said internal memory and when running operable to maintain a library of notes, said second program also operable to establish links between at least one of said notes and one of said contacts.

2. The personal electronic device of claim 1 wherein said second program is operating whenever the personal electronic device is operating.

3. The personal electronic device of claim 1 wherein said second program is manually activated or deactivated by a user.

4. The personal electronic device of claim 1 further comprising:
a receiver operable to receive signals corresponding to telephone calls, wherein said second program automatically activates when said receiver receives a signal corresponding to a telephone call.

5. The personal electronic device of claim 4 wherein said second program is operable to automatically display any of said notes in said library of notes linked to a first of said contacts in said library of contacts upon said receiver receiving a signal corresponding to a telephone call from the person associated with said first contact.

6. The personal electronic device of claim 1 further comprising:
a receiver operable to receive signals corresponding to text messages, wherein said second program automatically activates when said receiver receives a signal corresponding to a text message.

7. The personal electronic device of claim 6 wherein said second program is operable to automatically display any of said notes in said library of notes linked to a first of said contacts in said library of contacts upon said receiver receiving a signal corresponding to a text message from the person associated with said first contact.

8. The personal electronic device of claim 1 further comprising:
a receiver operable to receive signals corresponding to instant messages, wherein said second program automatically activates when said receiver receives a signal corresponding to a instant message.

9. The personal electronic device of claim 8 wherein said second program is operable to automatically display any of said notes in said library of notes linked to a first of said contacts in said library of contacts upon said receiver receiving a signal corresponding to an instant message from the person associated with said first contact.

10. The personal electronic device of claim 1 further comprising:
a receiver operable to receive signals corresponding to electronic mail messages, wherein said second program automatically activates when said receiver receives a signal corresponding to a electronic mail message.

11. The personal electronic device of claim 10 wherein said second program is operable to automatically display any of said notes in said library of notes linked to a first of said contacts in said library of contacts upon said receiver receiving a signal corresponding to an electronic mail message from the person associated with said first contact.

12. The personal electronic device of claim 1 wherein said second program automatically activates when said first program is activated.

13. The personal electronic device of claim 1 wherein said second program is operable to link a particular one of said notes with more than one of said contacts.

14. The personal electronic device of claim 1 wherein said second program is operable to create one of said notes to include text, pictures, video clips, and audio clips.

15. The personal electronic device of claim 1 further comprising:
a transmitter operable to transmit a signal corresponding to a telephone call, wherein said second program is operable to display at least one of said notes with a button that can be engaged by a user such that upon clicking said button the transmitter is engaged and a telephone call is initiated to said contact linked with said at least one note.

16. The personal electronic device of claim 1 further comprising:
a transmitter operable to transmit a signal corresponding to a text message, wherein said second program is operable to display at least one of said notes with a button that can be engaged by a user such that upon clicking said button the transmitter is engaged and a text message is initiated to said contact linked with said at least one note.

17. The personal electronic device of claim 1 further comprising:
a transmitter operable to transmit a signal corresponding to an electronic mail message, wherein said second program is operable to display at least one of said notes with a button that can be engaged by a user such that upon clicking said button the transmitter is engaged and an electronic mail message is initiated to said contact linked with said at least one note.

18. The personal electronic device of claim 1 wherein said second program is operable to display a background in at least one of said notes and said background includes an advertisement.
